(19) United States
(12) Patent Application Publication
(10) Pub. No.: US 2014/0039811 A1
(43) Pub. Date: Feb. 6, 2014

(54) METHOD OF DETERMINING UNCOLLECTED ENERGY

(71) Applicants: Werner Hinrich Bohlen, Emden (DE); Nuno Braga, Matosinhos (PT); Andreas Schmitz, Leca da Palmeira (PT)

(72) Inventors: Werner Hinrich Bohlen, Emden (DE); Nuno Braga, Matosinhos (PT); Andreas Schmitz, Leca da Palmeira (PT)

(73) Assignee: WOBBEN PROPERTIES GMBH, Aurich (DE)

(21) Appl. No.: 13/984,464

(22) PCT Filed: Feb. 8, 2012
(86) PCT No.: PCT/EP12/52098

§ 371 Date: Oct. 18, 2013

(30) Foreign Application Priority Data
Feb. 8, 2011 (DE) 10 2011 003 799.3

(51) Int. Cl. G01L 3/24

(52) U.S. Cl. CPC G01L 3/24
USPC 702/44

(57) ABSTRACT

The present invention concerns a method of producing a data base which includes a plurality of correlation laws, in particular correlation factors, for determining lost energy, which during a stoppage or throttling of a first wind power installation cannot be converted thereby into electrical energy, from the recorded power of at least one reference wind power installation operated in throttled or unthrottled mode, comprising the steps of simultaneously detecting instantaneous power of the first wind power installation and at least one reference wind power installation in the throttled or unthrottled mode, determining a respective correlation law, in particular correlation factor, describing a relationship between the power of the first wind power installation and the power of the at least one reference wind power installation, and storing the at least one correlation law or correlation factor in dependence on at least one boundary condition.

### BACKGROUND

1. Technical Field

The present invention concerns a method of determining lost energy which a wind power installation does not take from the wind during a stoppage or a throttling situation but which it would have been able to take from the wind without the stoppage or throttling. The invention also concerns the recording of data which can be used for determining said lost energy. In addition the present invention concerns a wind power installation in which such lost energy can be determined. The present invention further concerns a wind farm in which at least the lost energy of a wind power installation can be determined.

2. Description of the Related Art

Wind power installations are generally known. They include for example a pylon with a pod arranged thereon which includes a rotor with rotor blades arranged on a spinner or a hub, as shown in an example in FIG. 1. The rotor, which essentially comprises the rotor blades and the spinner, is caused to rotate by the prevailing wind and as a result drives a generator which converts that kinetic energy into electric energy or in relation to an instantaneous value into electric power. That electric power or energy is usually fed into an electric supply network and is suitably available to consumers. Often a plurality of such or other wind power installations are set up in mutually adjacent relationship and can thus form a wind farm. In that case the wind power installations can be set up for example at some hundred meters away from each other. A wind farm is in that respect usually but not necessarily distinguished by a common feed-in point. In that way the entire power respectively produced by the wind farm, that is to say the sum of all wind power installations of the wind farm can be fed into the electric network centrally at one location, namely the feed-in point.

It can occasionally happen that a wind power installation is stopped or throttled although the wind conditions permit operation of the wind power installation, in particular unthrottled operation thereof. Such a stoppage of the wind power installation can be necessary for example for maintenance operations or in the event of faults. It can also happen that, to control the supply network, the network operator who is operating the supply network prescribes, in respect of a wind power installation, that throttled or no power at all is to be fed into the network for a given period. A throttled mode of operation is also considered for example for emission protection reasons, in particular to limit sound emissions by operation in a reduced-sound mode, or to avoid or reduce a moving shadow effect. Further possible examples in terms of a reduction are setting requirements on the part of the network operator, ice accretion or a reduction or shutdown when people access the installation. In principle reductions or shutdowns may be relevant for safety reasons such as for example when there is a risk of ice fall, and/or for emission protection reasons such as for example for sound reduction, and/or for internal technical reasons such as for example upon an excessive increase in temperature, and/or for external technical reasons, such as for example in the event of overvoltage in the connected network, or if for example the aerodynamics are diminished due to ice accretion.

In particular stoppage of the wind power installation is usually undesirable for the operator of the wind power installation because in that case he suffers from disruption in remuneration due to electric energy not being fed into the supply network. Depending on the respective reason for the shutdown or reduction, a claim for remuneration for the lost or escaped energy may arise in relation to a third party such as for example the network operator. It is therefore important to determine that lost energy which basically represents a fictional value. In that respect it is desirable for that amount of energy to be determined as accurately as possible as otherwise the resulting remuneration is notaccurately determined and the operator of the wind power installation could be put at a disadvantage or could be put at an advantage.

The detection of such lost energy is also referred to as production-based availability or energy availability, which is usually specified as a percentage value, in relation to the energy which could have been produced without the failure. That term is also used to distinguish it in relation to the term of time-based availability which only specifies the period—for example as a percentage in relation to a full year—in which the wind power installation was stopped and was thus not available.

To determine production-based availability or for determining the lost energy for billing thereof, it is possible for the basis adopted in that respect to be the operating characteristic of the wind power installation in question. The operating characteristic gives the power produced in dependence on the wind speed. If the wind power installation is stopped or throttled, then because of the prevailing wind speed which is known on the basis of measurement, it is possible to read out of that power characteristic the associated power which the wind power installation would have delivered in accordance with that power characteristic. A particular problem in that respect is that it is difficult to reliably and accurately determine the prevailing wind speed. Admittedly, wind power installations usually have a wind measuring device such as for example an anemometer, but in actual fact such a device is usually not employed to control the wind power installation or is only very restrictedly used for that purpose. The operating point of a wind power installation is for example usually set in dependence on a rotor rotary speed or the rotor acceleration if the wind power installation involves a rotary speed-variable concept or is a rotary speed-variable installation. In other words, the wind power installation or its rotor is the single reliable wind measuring sensor which however in the stopped condition cannot give any information about the wind speed.

Another possible option would be to use a measuring mast for measuring the wind speed in order either to use the wind speed measured therewith and, by way of the aforementioned power characteristic, to determine the power which in accordance with the characteristic could have been produced. In this case also an uncertainty factor is the accuracy of the measuring mast. Added to that is that the measuring mast is set up at a spacing from the wind power installation and as a result falsifications occur between the wind speed at the measuring mast and at the wind power installation in question. Added to that is the fact that, although only the wind speed is taken into consideration in the power characteristic, the wind speed does not adequately characterize the wind. Thus for example the wind can lead to different effects at the wind power installation and in corresponding fashion to differing power generation, for a—calculated—average value, depending on whether the wind is very constant or very gusty.

It has also already been proposed that a measuring mast or a so-called meteo-mast can be correlated with one or more weather stations in order thereby to improve information in relation to the prevailing weather situation, in particular the prevailing wind. In particular in that way the measurements of the meteo-mast become less susceptible to local fluctuations in the wind.

### BRIEF SUMMARY

One embodiment of the invention is directed to a method of producing a data base. That data base includes a plurality of and in particular a large number of correlation factors used for determining lost energy. Accordingly a case is considered, in which a first wind power installation is stopped or is operated in a throttled mode.

To simplify the description here, the basic starting point initially adopted is a wind power installation which is stopped. In that case the currently prevailing power of at least one reference wind power installation which is operating in the unthrottled mode is detected. In principle it is also possible to take as the basic starting point a reference wind power installation which is operated in a throttled mode. For better description however the basic starting point initially adopted is an unthrottled wind power installation. That wind power installation which is operated in the unthrottled mode delivers a power which can be measured or the value of which is contained in such a way that it can be called up in the control of that reference wind power installation. Now, taking that known power, by way of a previously recorded correlation and in particular by way of a previously recorded correlation factor, the power to be expected of the first wind power installation which at the time is stationary can be calculated from that known power. If therefore for example the reference wind power installation is operated in the unthrottled mode and in that case delivers 1 MW power and the correlation factor is for example 1.2, then the expected power of the first wind power installation which is stationary at the time would amount to 1.2 MW. The term currently prevailing values such as powers or environmental conditions such as the wind direction is used in principle to denote instantaneous values or values of instantaneously prevailing conditions.

That correlation factor is recorded for given operating points and in that respect the basis adopted is not just one correlation factor between that one reference wind power installation and the first wind power installation, but a plurality thereof, in particular a large number of correlation factors. In principle a correlation between the power of the reference wind power installation and the power of the first wind power installation can be described other than by a factor, such as for example by a first or higher order function. The use of factors however represents a comparatively simple solution. The accuracy in terms of ascertaining the power to be expected of the first wind power installation from the respectively currently prevailing power of the reference wind power installation is possible by determining and using a correspondingly large number of factors which are used for a correspondingly large number of situations and suitably previously recorded.

One or more embodiments of the invention concerns both the detection of the lost energy and also the detection of the correlation factors required for that purpose and thus the generation of a corresponding data base.

Preferably those correlations which can also be referred to as correlation laws, in particular the correlation factors, are detected in dependence on boundary conditions and suitably stored. In that respect correlations can be recorded between the first wind power installation and a further reference wind power installation or installations.

In an embodiment absolute values of the power of respective operating points are recorded, in particular in dependence on the wind speed or the wind direction. The recording operation is preferably effected for each wind power installation but alternatively or additionally can also be recorded as a value for an entire wind farm. Preferably those values are recorded together with correlation factors for each wind power installation, and stored in a data base. Those absolute values are used when no reference wind power installation is appropriately available, in particular when all wind power installations in a wind farm are stopped or are being operated in a throttled mode. That can be the case for example upon a reduction in the delivery power of the entire wind farm in accordance with a setting requirement by the network operator. In such a case or a similar case, the power to be expected is read out of the data base for each wind power installation, in dependence on the wind speed and the wind direction. The energy to be expected of the wind power installation in question and also the wind farm overall can be calculated therefrom.

Specific measurement and storage of actual power values in dependence on wind direction and wind speed provides a very accurate, well-reproducible basis for determining the power to be expected. This avoids producing and using complex models. For determining the overall power to be expected of a wind power installation, for example the individual powers to be expected of the wind power installations are added, or for example a stored total power to be expected in respect of the wind farm is read out of a data base. The wind strength and wind direction are detected for example at a central point in the wind farm, in particular at a measuring mast. Otherwise all aspects, points of explanation and configurations which are referred to in connection with the correlation factors also appropriately apply to the storage and use of absolute power values, insofar as applicable.

Preferably correlations between all wind power installations of a wind farm are recorded. When using a plurality of reference wind power installations, in regard to the respective correlations, the reference wind power installation in question is also stored in the storage procedure. A plurality of reference wind power installations can be used for example to select at least one particularly highly suited reference wind power installation in accordance with respective further boundary conditions, and/or it is possible to use a plurality of reference wind power installations in order to redundantly determine the power to be expected in order thereby to carry out a comparison for error minimization. It is also possible to use a plurality of reference wind power installations in order then to be able to determine a power to be expected of the first wind power installation if for unforeseen reasons a reference wind power installation fails.

Preferably the choice of a reference wind power installation is effected in dependence on boundary conditions like for example the wind direction. Thus a reference wind power installation can possibly be more or less representative, in dependence on the wind direction, of the performance of the first wind power installation, namely the wind power installation to be investigated. If for example there is an obstacle between the first wind power installation and the selected reference wind power installation, then that can lead to at least partial disjunction of the behaviors of both wind power installations if the wind blows from the reference wind power installation to the first wind power installation or vice-versa. If however the wind is such that the two wind power installations are beside each other from the point of view of the direction of the wind, the influence of such an obstacle is slight.

In that respect—as the man skilled in the art will understand—a reference wind power installation is a reference wind power installation which is set up in the proximity of the first wind power installation. In that respect that proximity can involve a spacing of several hundred meters or even one or more kilometers as long as the behavior of the reference wind power installation still leads to an expectation of a sufficient relationship in its behavior to the first wind power installation. That can depend on specific circumstances such as for example the terrain. The more uniform the terrain is and the fewer obstacles on the terrain, it is correspondingly more to be expected that even a reference wind power installation which is set up at a further spacing away still enjoys an adequate relationship to the first wind power installation.

Preferably the currently prevailing power of the reference wind power installation, the currently prevailing wind direction or the currently prevailing wind speed each form a respective boundary condition, in dependence on which the correlation is recorded and stored. The method is described hereinafter in connection with correlation factors. The points of explanation can also be applied in principle to other correlations. Preferably the current wind speed and wind direction each form a respective boundary condition. Accordingly a correlation factor between the first wind power installation and the reference wind power installation in question is recorded, both in dependence on the wind direction and also in dependence on the wind speed. Thus for example a correlation factor of 1.2 can prevail with a wind speed of 7 m/s and a wind direction from the North, whereas with the same wind speed but a wind direction from the South, for example a correlation factor of 1.4 is detected. If—to give a further example—the wind speed is only 6 m/s with the same wind direction, the correlation factor could be for example 1. All those values are recorded and stored in a data base. In the example with the wind direction and speed as respective boundary conditions, that would give a two-dimensional data base field for each reference wind power installation. If those values are recorded for a plurality of reference wind power installations then—talking figuratively—that gives a three-dimensional data field with identification of the reference wind power installation as a further variable parameter. The nature of the storage or the construction of the data base can also be such that correlation factors are recorded for all wind power installations of a wind farm and are stored in a matrix and such a matrix is recorded for each value of a boundary condition.

Alternatively or additionally the current power of the reference wind power installation can be used as a boundary condition. That power could form the basis for example in place of the wind speed. Accordingly therefore the prevailing wind direction, for example wind from the North, and the prevailing power, for example 1 MW, would firstly be determined as the boundary condition. Then the relationship between the power of the first wind power installation and the reference wind power installation is determined and stored for those boundary conditions, namely wind from the North and produced power of 1 MW, in the data base for that first reference wind power installation. If now the first wind power installation is stopped for example for maintenance its power to be expected can then be determined. For that purpose the correlation factor for the boundary conditions, that is to say for example the correlation factor for wind from the North at a wind speed of 7 m/s is read out of the data base or alternatively, if the data base or the data base set is appropriately designed, the correlation factor for the boundary condition of wind from the North and 1 MW of produced power is read out of the data base. That correlation factor is then multiplied in both the indicated cases by the produced power of the reference wind power installation to determine the power to be expected of the first wind power installation.

In the second alternative indicated, the instantaneous produced power of the reference wind power installation thus performs a dual function. Firstly it is used to read the associated correlation factor out of the data base and thereafter it is used to calculate the power to be expected of the first wind power installation, with the read-out correlation factor.

Preferably the current power of the reference wind power installation, at any event insofar as it is used as a boundary condition, the current wind direction and/or the current wind speed are divided into discrete regions. It is possible in that way to limit the size of the data base. If for example the power of the reference wind power installation is subdivided into 1% steps with respect to its nominal power, that would give therefore a division into 20 KW regions or steps for a wind power installation with a nominal power of 2 MW. That however only concerns the power insofar as it is used as a boundary condition, that is to say insofar as it is used to store the correlation factor in the data base or to read it therefrom. For specifically calculating the power to be expected of the first wind power installation however the correlation factor is multiplied by the actual power which is not divided into discrete regions. It will be appreciated that it would also be possible to effect multiplication by the power divided into discrete regions, particularly when the discrete regions lie in the order of magnitude of the accuracy of power measurement.

The wind speed can be divided for example into 0.1 m/s steps or regions and the wind direction can be divided for example into 30° sectors.

If for example discretization of the wind directions into 30° sectors and discretization of the wind speed into 0.1 m/s steps is effected for a reference wind power installation having a start-up wind speed or a so-called ‘cut-in’ wind speed of 5 m/s and a nominal speed of 25 m/s, that gives a data field of 360 degrees/30 degrees=12 wind speed sectors times (20 m/s)/(0.1 m/s)=200 wind speed steps and thus a data field with 2400 fields, that is to say 2400 correlation factors for that reference wind power installation given by way of example.

Preferably the correlation factors are recorded and stored in a regular mode of operation in order thereby to successively fill the data base with the correlation factors. Optionally and/or as required correlation factors which could not yet be determined by measurements can be calculated from already existing correlation factors, in particular interpolated or extrapolated. Also when using a correlation law other than a correlation factor, for example a first-order correlation function, it is possible to effect interpolation or extrapolation, for example by interpolation or extrapolation of coefficients of such a correlation function. It is therefore proposed that the first wind power installation and the at least one reference wind power installation are operated irrespective of a need for determining correlation factors. In that respect—insofar as the installations are operated at all—a given operating point and thus corresponding boundary conditions such as wind direction and wind speed necessarily occur. For that purpose a correlation factor is recorded and stored in the data base, having regard to the prevailing boundary conditions. Preferably that is effected for all wind power installations of the wind farm with each other. If the operating point and therewith the boundary condition changes a correlation factor is calculated afresh and stored under the new boundary conditions and thus in a different address in the data base.

In that way the data base only includes the correlation factors for the boundary conditions, under which the wind power installation has already been operated. If now the first wind power installation is shut down and an operating point for the reference wind power installation is set, for which no correlation factor was previously recorded, then that can be calculated from adjacent correlation factors which have already been stored, that is to say from correlation factors which were already recorded in relation to similar boundary conditions. For example the correlation factor for a wind direction of the sector 0 to 30° and the wind speed of 10 m/s can be interpolated from two correlation factors, of which one was recorded for the wind direction sector of 330 to 360 degrees at a wind speed of 9.9 m/s, and the other was recorded in a wind direction sector of 30 to 60° at a wind speed of 10.1 m/s. That is only intended as a simple example for calculation by interpolation. It is equally possible to use a plurality of correlation factors for calculating or estimating a missing correlation factor.

If not many correlation factors have yet been recorded, because for example the wind power installations in question have not yet been long in operation, in particular in the first year of operation of a wind farm, calculation of the lost energy can be effected retroactively for the past period of time such as for example the past year. For that purpose the data of the produced power of the reference installations are stored. At the end of the relevant period the lost energy can then be calculated from the stored power data and the correlation factors which have been detected in the meantime until then. That has the advantage that until then more correlation factors could be recorded and thus fewer interpolation or extrapolation procedures are required or can be entirely omitted.

As further boundary conditions, for example environmental conditions such as temperature, air pressure, air humidity and density of the air can be recorded. Those boundary conditions which are specified by way of example and which are in part physically interrelated can influence the operation of the wind power installation and can find a corresponding counterpart in the correlation factor in question. Taking account of a plurality of boundary conditions can lead to a multi-dimensional data base for the correlation factors.

It will be noted however that the method of detecting the lost energy is tolerant in terms of variations in boundary conditions and in particular also in respect of inaccuracies in measurements such as wind speed. More specifically the proposed method has at least a two-stage concept.

In the first stage a correlation factor is selected, in dependence on boundary conditions. Due to taking account of the boundary conditions, that correlation factor reproduces a quite accurate and in particular reliable correlation.

In the second stage the corresponding correlation factor is multiplied by the power of the reference wind power installation. That makes it possible to take account of influencing factors such as air density without them having to be recorded. If for example air density is not taken into consideration as a boundary condition when selecting the correlation factor, it is however involved indirectly, without express measurement, in the power of the reference wind power installation. Therefore, with an air density, there is a correspondingly high power level for the wind power installation because air of high density contains more kinetic energy. Thus, by multiplication by the—air density-independent-correlation factor, with a higher power from the reference wind power installation, that also gives a higher calculated power to be expected of the first wind power installation. When determining the power to be expected of the first wind power installation by way of wind speed measurement and the power characteristic of the first wind power installation, the air density—to continue with that example—would still be disregarded. That would give a correspondingly erroneously calculated power to be expected of the first wind power installation.

The method is also for example tolerant in relation to inaccurate measurement of the wind speed. That is already of significance for the reason that it is precisely wind speed that is difficult to measure, and is subject to major errors. With the proposed method, the wind speed is only involved in determining the correlation factor, if it is involved in any way at all. If the measured wind speed is for example about 10% above the actual wind speed, then on the one hand this is involved in determining and correspondingly storing the correlation factor in question, but on the other hand it is also involved when the correlation factor is read out again, if that is effected in dependence on wind speed. That systematic error which is given by way of example is however thereby rectified again. In other words, in this case, the wind speed serves only for approximately recognizing the underlying operating point again. The extent to which the absolute value of the wind speed is faulty is not involved here, as long as the same value was reproduced again.

If a random error occurs in measurement of the wind speed, which however is usually not to be expected to a major degree, that can at most result in an incorrect correlation factor being read out. It will be noted however that in that case at least one correlation factor of a similar wind speed may be read out, which may vary to a lesser degree than the wind speed itself. In this case also the method is therefore found to be error-tolerant.

The method described hitherto for the situation involving stoppage of the first wind power installation can in principle also be applied to the case of throttling of the first wind power installation. If for example the first wind power installation is throttled to reduce noise, whereas a reference wind power installation is not throttled because for example it is smaller and basically is so constructed as to produce less noise or is set up at a greater distance from a center of population than the first wind power installation, then the power to be expected of the first wind power installation can be determined in the unthrottled mode in the above-described manner. The lost energy is calculated from the difference in the power in the throttled mode and the calculated power to be expected in the unthrottled mode. For the sake of completeness it is also pointed out that it is clear to the man skilled in the art that the lost energy arises out of the lost power, integrated over the relevant period of time. In the simplest or simplified case, that means multiplication of the lost power by a corresponding period of time.

Preferably it is proposed that, to determine the power to be expected of the first wind power installation, a plurality of reference wind power installations are used. When detecting the correlation factors or other correlations it is possible to proceed individually as described for each reference wind power installation so that this gives a data set for each reference wind power installation. It is also possible to simultaneously record the correlations between all wind power installations being considered and respectively write them into a matrix. If then, when the first wind power installation is stopped, its power to be expected is calculated, that can be effected in each case by means of each of the reference wind power installations by a respective correlation factor relating to that reference wind power installation being read out and multiplied by its instantaneous power in order to calculate the power to be expected of the first wind power installation. In the ideal case in that respect the same power to be expected of the first wind power installation results from each reference wind power installation. If that ideal result is attained, that confirms the quality of calculation of the power to be expected. If however there are deviations, then the powers to be expected, which are determined a plurality of times and thus redundantly, can be used in order thereby to calculate a single power to be expected. For that purpose it is possible for example to use a simple average value by a procedure whereby therefore all given powers are added up and divided by the number. Optionally however a reference wind power installation can be classified as relevant and the value ascertained by it can be taken into consideration to a greater degree by way of a weighting. Another possible option involves using the method of the least error squares. Therefore a common power value to be expected is determined, in respect of which the squares of each deviation in relation to the powers to be expected, which are individually determined, afford in total the least value.

Preferably the currently prevailing wind direction and/or wind speed at the reference wind power installation, in the first wind power installation and/or at another measuring point, in particular a measuring mast, is detected. If the first wind power installation is in a stopped condition, nonetheless a part of the measuring technology such as for example evaluation of the pod anemometer can still be in operation and thus at any event can determine the approximate wind speed of the first wind power installation and use it as the basis for the further course of the method. It may however be advantageous to use the wind speed of a reference wind power installation because in that way a high correlation with the power of that reference wind power installation is to be expected. In that respect as far as possible measurement should be effected at the same respective location when detecting the correlation factors and reading them out. The use of a measuring mast can be advantageous because often better wind speed measurement is possible there. In particular wind speed measurement at a wind mast is not disturbed by being briefly shadowed by rotor blades, as is usually the case with pod anemometers of a running wind power installation. In addition the measuring mast can represent a neutral point for measurement, if a plurality of wind power installations are used as reference wind power installations. It may be advantageous to use a measuring mast which is set up in and for a wind farm and which supplies a representative measuring parameter for the wind farm overall. The use of values of a close weather station, either as direct values or for comparison of the wind speed measured with a measuring mast or a wind power installation, can be advantageous and can improve the quality of the measuring results.

According to the invention a wind power installation is equipped with a described method of detecting the correlation laws, in particular the correlation factors, and/or with a method of determining the lost energy.

According to the invention there is also proposed a wind farm equipped with at least one of the above-described methods. In such a wind farm—but not only in such a farm—data exchange between wind power installations can be implemented for example by way of a SCADA. Such a data exchange system can also be used to exchange the data necessary for the described methods.

Thus there is proposed a solution, namely corresponding methods and also a wind power installation or a wind farm, with which lost energy can be calculated. For that purpose power of a stopped wind power installation or a wind power installation which is operated in a throttled mode is calculated and the lost energy, that is to say the energy which according to calculation could have been produced, delivered and correspondingly remunerated, can be determined over the time in question. Basically this involves a notional power or notional energy which is to be suitably accurately determined, in the interest of taking as correct account as possible of the party who is expecting a remuneration and also a party who must provide such remuneration.

It is thus possible to calculate production-based availability of the wind power installation. Such production-based availability which based on that English term, is also abbreviated to PBA, is frequently specified as the quotient of the measured energy production (MEP) divided by the expected energy production (EEP), the basis adopted being a period of a year or a month. For production-based availability PBA for example calculation in accordance with the following formula is considered:

PBA=MEP/EEP.

The PBA can be defined differently and accordingly other formulae can be employed. The parameters of the above formula can also be defined differently. A possible option for the parameters of the foregoing formula is explained hereinafter.

The actually produced energy of the year (MEP) can be recorded by a suitable measuring unit over the year, such as for example by a current meter or energy meter. Such measurement of the produced energy is usually implemented in a wind power installation and it is possible to have recourse to the data.

The expected energy production, that is to say the expected conversion of wind energy into electric energy (EEP) is thus the total of the actually produced energy (MEP) and the lost energy, the calculation or determination of which is effected in accordance with the invention and in particular is improved. More specifically according to the invention there is proposed a method in which power outputs are correlated between wind power installations in particular of a wind farm. A preferred variant provides producing a matrix which respectively contains a correlation factor between each wind power installation considered in that respect, that is to say in particular between each wind power installation of a farm. Such a matrix is illustrated hereinafter by way of example for a wind power installation which is respectively referred to in the matrix as WEC1, WEC2, WEC3, WEC4 to WECn. The values entered are only by way of example.

TABLE 1

| Production | | | | | | |
|---|---|---|---|---|---|---|
| correlation | WEC1 | WEC2 | WEC3 | WEC4 | . . . | WECn |
| absolute | 1.2 MW | 1.2 MW | 1.4 MW | 1 MW | . . . | 0.9 MW |
| WEC1 | 1 | — | — | — | — | — |
| WEC2 | 1.15 | 1 | — | — | — | — |
| WEC3 | 0.84 | 1.24 | 1 | — | | — |
| WEC4 | 0.98 | 0.78 | 1.01 | 1 | | — |
| . . . | . . . | . . . | . . . | | 1 | — |
| WECn | 1.02 | 1.06 | 1.08 | 0.98 | . . . | — |

That matrix can be viewed as a reference product correlation of the wind farm. That matrix contains for example the factors for a wind speed of 8 m/s and a wind direction of 30°, which for example can identify a range of 0-30°. In addition it contains absolute values which can possibly be used if the other reference installations are also stationary or throttled.

If now a wind power installation is stopped or is operated in a throttled mode its expected power and thus the expected produced energy can be calculated from at least one actual power or energy of one of the other wind power installations, by way of the correlation factor.

At the end of an agreed period such as for example annually or monthly the production-based availability (PBA) can thus be calculated. Preferably the reference data used are only those data which were recorded in the unthrottled mode. The longer the wind farm was already operated in the unthrottled mode—here there can be periods therebetween, in which that was not the case—the correspondingly more complete and possibly better can the data base be.

The foregoing Table can also be recorded for different wind directions and different wind speeds or also other boundary conditions so that many such tables are available or together form a data base for a wind farm or other wind power installation assembly.

### BRIEF DESCRIPTION OF THE SEVERAL VIEWS OF THE DRAWINGS

The invention is described by way of example hereinafter by means of embodiments with reference to the accompanying drawings.

FIG. 1 shows a known wind power installation,

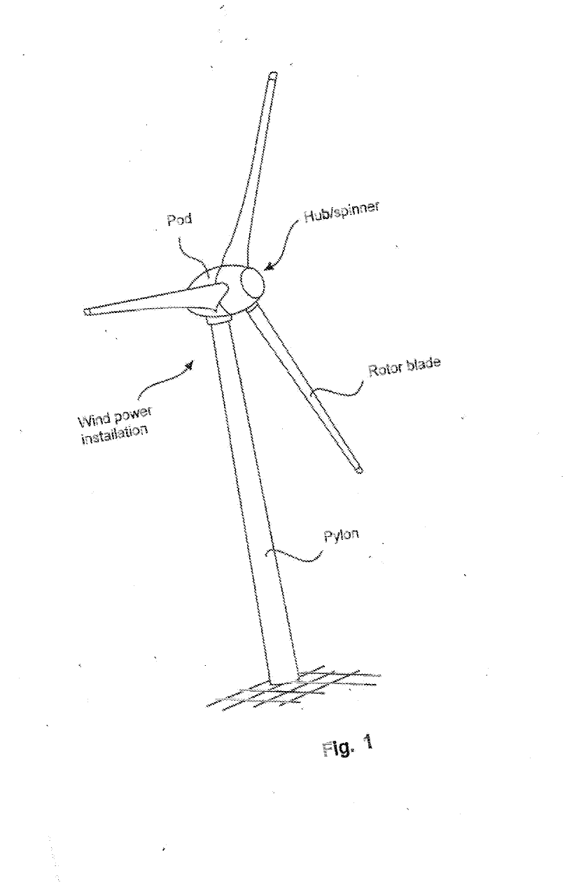

FIG. 2 shows a flow chart for the detection of correlation coefficients, and

FIG. 3 shows a flow chart for the detection of lost energy.

FIG. 4 shows a block diagram representative of a wind power farm.

### DETAILED DESCRIPTION

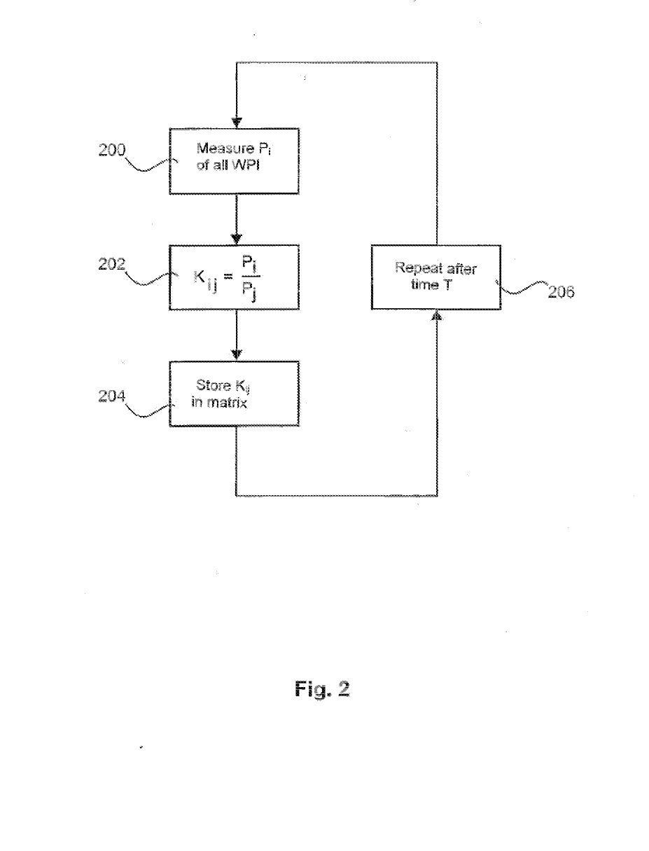

Referring to FIG. 2 correlation parameters for the relationship of a plurality of wind power installations with each other are recorded. In particular that is directed to the correlation of some or all wind power installations of a wind farm. The power output of each of the wind power installations is measured in the measuring block 200. That usually means that the power available in each wind power installation is used or provided for the following steps. The power and also the further necessary data to be exchanged can be implemented for example by way of a so-called SCADA system.

Correlation factors between the respective powers recorded in the measuring block 200 are calculated in the calculating block 202. The formula for that reads as follows:

$$Kij = \frac{Pi}{Pj}$$

The factor Kij thus represents the correlation between the power Pi of the wind power installation i and the power Pj of the wind power installation j. The indices i and j are thus integral operating variables.

The correlation factors Kij calculated in that way are then stored in the memory block 204 in a matrix in the next step. The matrix corresponds for example to Table 1.

In the simplified procedure in accordance with blocks 200, 202 and 204 all correlation factors between all wind power installations of the farm are recorded and stored, with respectively identical boundary conditions. Depending on the respective conditions the corresponding matrix which is thus linked to the respective boundary conditions like wind direction and speed is selected. The diagrammatically illustrated procedure initially presupposes that all wind power installations are running in the normal mode of operation, that is to say they are running unthrottled. Throttled wind power installations can possibly also be taken into account, or the power of the throttled wind power installations is not taken into consideration and the correlation factors in question are correspondingly also not calculated. The corresponding entries in the matrix then remain free.

The illustrated method is successively repeated by way of the repetition block 206. For that purpose it is possible for example to establish a repetition time T which for example can be 10 min. The illustrated procedure in FIG. 2 would then be performed every 10 min.

If a correlation factor or a plurality of correlation factors, in relation to which values are already stored, are determined in the repetition procedure then either the respectively freshly determined correlation factor can be discarded, it can replace the correlation factor already present at its position, or the stored correlation factor can be improved by a procedure whereby for example averaging of all previously recorded values of that correlation factor, that is to say that entry, is implemented. It can also be provided that only some such as for example the last 10 values are taken into consideration in that case and correspondingly form an average value.

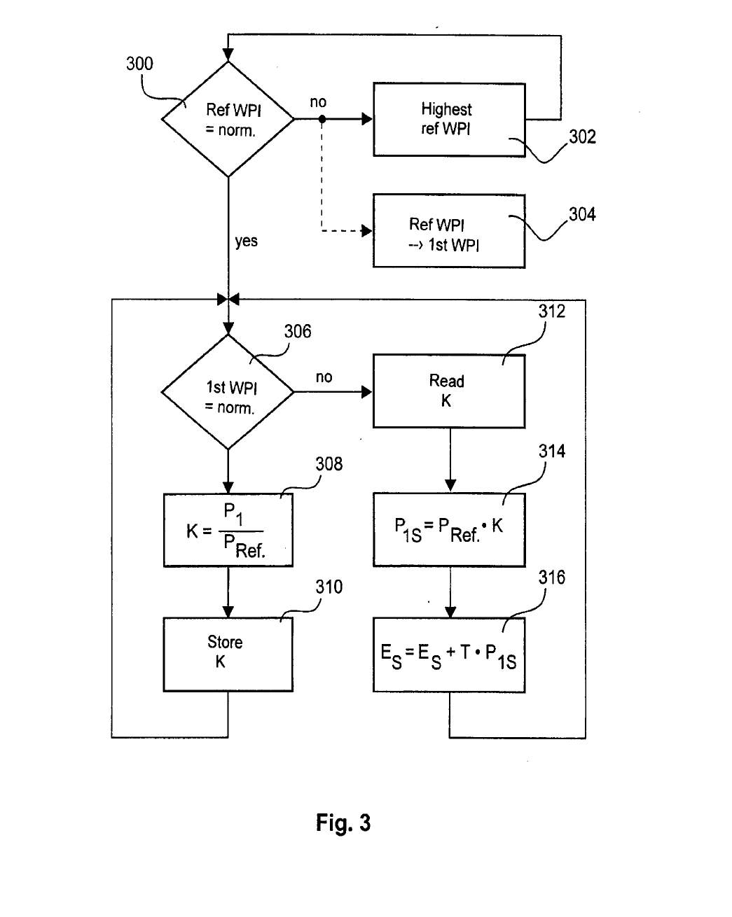

FIG. 3 shows a method which initially considers only two wind power installations, namely a reference wind power installation and a first wind power installation. The method of FIG. 3 can be extended to various wind power installations or pairs of wind power installations until all wind power installations of the wind farm have been taken into account. In that case the illustrated method can also be performed a plurality of times in parallel in relation to different wind power installations. Here too calculation and/or necessary data transmission can be effected by means of a SCADA.

FIG. 3 firstly shows a first enquiry block 300 in which a check is made to ascertain whether the selected reference wind power installation is operating in the normal mode, that is to say unthrottled. If that is not the case then another wind power installation can be selected as the reference installation in accordance with the change block 302. The procedure is re-started with that next wind power installation in the first enquiry block 300.

In addition the reference wind power installation which is just being investigated and which is not running in the normal mode and in particular is stopped can be selected as the first wind power installation. That is shown by the selection block 304. In that respect the first wind power installation is that for which the lost power or energy is to be determined, for which therefore the power or energy to be expected is to be calculated.

As soon as a selected reference wind power installation is operating in unthrottled mode, the first enquiry block 300 branches to the second enquiry block 306. The second enquiry block 306 basically checks the same thing which the first enquiry block 300 also checked, but for the first wind power installation. If the first wind power installation is operating unthrottled, that is to say in the normal mode, then the second enquiry block 306 further branches to the calculation block 308. The correlation factor K is calculated in the calculation block 308 from the coefficient of the power of the first wind power installation and the power of the reference wind power installation. That correlation factor K is stored in a data base in the subsequent memory block 310. In that case preferably boundary conditions such as prevailing wind directions and wind speed are also recorded. Finally, after the memory block 310, the method goes back to the second enquiry block 306 again and the blocks 306, 308 and 310 are implemented afresh, possibly after a time delay of for example 10 min. If the method is operating in that loop of those three blocks 306, 308 and 310, then basically acquisition of the correlation factors K takes place specifically for those two wind power installations, namely a reference wind power installation and the first wind power installation. The wind power installations are therefore in the normal mode of operation and progressively build up the data base required for a non-normal mode.

If it is established in the second enquiry block 306 that the first wind power installation is not in the normal mode and is therefore operating in a throttled mode or is stopped, the procedure branches to the reading block 312. The correlation factor K is now read out in that block in accordance with the previously produced data base, in particular having regard to boundary conditions like the prevailing wind speed and direction. If the correlation factor in question is not stored in the data base it can possibly be interpolated from other already existing correlation factors.

The expected power of the first wind power installation can then be determined from the reference power P_{Ref} of the reference wind power installation in the determining block 314, with the read-out correlation factor K. That power is referred to here as P_{1S}.

The energy determining block 316 then involves determining the associated energy by way of integration of the estimated or expected power P_{1S} over the corresponding time. As for simplification it is assumed here that there is a constant power P_{1S} for the period of time in question the energy is calculated by the multiplication of P_{1S} with the associated time value T. That energy can be added to the energy E_{S} which has already been previously calculated in order in that way to sum energy to be expected over an observation period such as for example a month or a year.

The time factor T of the energy determining block 316 can correspond to the time factor T of the repetition block 206 in FIG. 2. That however is not a necessary prerequisite. In particular it can be the case that every 10 min the described steps are repeated and an estimated power is determined in the determine block 314. In that case however the first wind power installation can possibly no longer be in the normal mode of operation only for example for 5 min. That information is available to the illustrated method and in spite of the repetition period of 10 min in this example the energy calculation would however only be based on the period of 5 min.

After the energy has been determined or supplemented in the energy determining block 316 the method re-starts at the second enquiry block 306 as described.

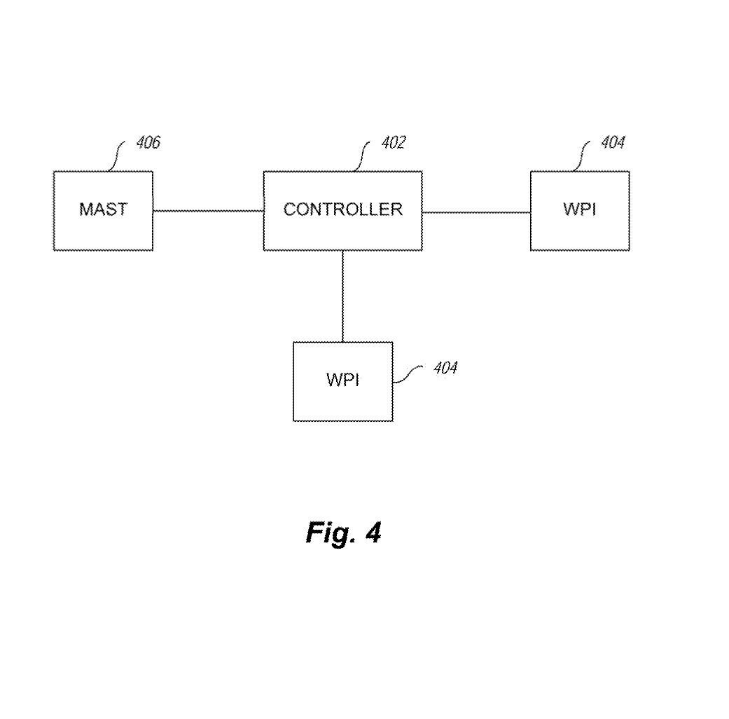

FIG. 4 shows a controller 402 coupled in communication, such as electrically, with a plurality of wind power installations 404, such as the first wind power installation and the reference wind power installation. The controller 402 may be further coupled to a measuring mast 406. The controller 402 may be located in one of the wind power installations 404, in the measuring mast 406, or may be located at a different remote location. The controller 402 may be a programmable microprocessor configured to carry out the sequences of steps shown in FIGS. 2 and 3.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of determining correlation of a first wind power installation and at least one reference wind power installation, the method comprising:
detecting instantaneous power of the first wind power installation and the at least one reference wind power installation;
determining a correlation law that describes at least one of a relationship between the power of the first wind power installation and the power of the at least one reference wind power installation and a boundary condition in which one of the first wind power installation and the at least one reference wind power installation is operating;
storing the correlation law; and
repeating determining and storing of a subsequent correlation law.

2. The method according to claim 1 wherein the at least one boundary condition is one of:
current wind direction;
current wind speed;
current power of the reference wind power installation;
current outside temperature; and
current air density.

3. The method according to claim 2 wherein at least one of
the current wind direction;
the current wind speed;
the current power of the reference wind power installation;
the current outside temperature; and
the current air density, is subdivided and stored into discrete regions for use as a boundary condition.

4. The method according to claim 1 wherein the correlation laws are recorded and stored in a first mode, the method further comprising:
determining and storing a plurality of correlation laws for a plurality of wind power installations; and
determining correlation laws between another wind power installation and the reference wind power installation by interpolating or extrapolating from the plurality of stored correlation laws.

5. The method according to claim 1 wherein a respective set of correlation laws is stored for three or more wind power installations for different values or different combinations of values of one or more boundary conditions, wherein a respective correlation law describes the correlation of two respective wind power installations thereof.

6. The method according to claim 1, further comprising:
wherein detecting instantaneous power of the first wind power installation and the at least one reference wind power installation comprises detecting instantaneous power of the first wind power installation and a plurality of reference wind power installations;
wherein determining a correlation law comprises determining a plurality of correlation laws for each of the reference wind power installations; and
storing the plurality of correlation laws.

7. A method of calculating an amount of lost energy associated with a first wind power installation, the method comprising:
detecting current power of at least one reference wind power installation in a throttled or unthrottled mode;
calculating an amount of lost power of the first wind power installation based on the power of the at least one reference wind power installation and a correlation factor that specifies a correlation between the power of the respective reference wind power installation and a power to be expected of the first wind power installation; and
calculating the amount of energy lost based on the calculated power to be expected and over an associated period of time;
obtaining a value of a previously stored power value of the first wind power installation or a plurality of wind power installations in dependence on at least one of the current wind direction and the current wind speed; and
calculating the amount of lost energy based on the lost power and an associated period of time.

8. The method according to claim 7 wherein the correlation factor is selected from a plurality of stored correlation factors in dependence on at least one of:
the current wind direction;
the current wind speed;
the current power of the reference wind power installation;
the current outside temperature; and
the current air density.

9. The method according to claim 7 wherein the at least one reference wind power installation is selected in dependence on a wind direction.

10. The method according to claim 7 wherein at least one of the current wind direction and the current wind speed is detected proximate the reference wind power installation, the first wind power installation or a measuring mast.

11. The method according to claim 7 wherein a plurality of wind power installations are selected and used as reference wind power installations to respectively calculate a power to be expected so that a plurality of powers to be expected are calculated, and an average power to be expected is calculated from the plurality of powers to be expected by averaging or by way of the method of least error squares.

12. A wind power installation for converting kinetic energy from the wind into electric energy including a controller adapted to carry out a method according to claim 1.

13. A wind farm comprising:
a plurality of wind power installations that includes a first wind power installation and at least one reference wind power installation; and
a controller configured to:
detect instantaneous power of the first wind power installation and the at least one reference wind power installation;
determine a correlation law that describes at least one of a relationship between the power of the first wind power installation and the power of the at least one reference wind power installation and a boundary condition in which one of the first wind power installation and the at least one reference wind power installation is operating; and
store the correlation law.

14. The wind farm according to claim 13 further comprising a measuring mast for detecting a wind speed prevailing in the wind farm.

15. The wind farm according to claim 13 wherein the controller is provided in one of the wind power installations or the measuring mast, the controller being adapted to selectively calculate the lost energy for each respective wind power installation of the plurality of wind power installations as the first wind power installation.

16. The method according to claim 1 wherein detecting instantaneous power of the first wind power installation and the reference wind power installation comprises detecting the instantaneous power of the reference wind power installation when it is a throttled mode.

17. The method according to claim 1 wherein detecting instantaneous power of the first wind power installation and the reference wind power installation comprises detecting the instantaneous power of the reference wind power installation when it is in an unthrottled mode.
